(19) United States
(12) Patent Application Publication
(10) Pub. No.: US 2006/0168753 A1
(43) Pub. Date: Aug. 3, 2006

(54) Combination squeegee and hand trowel tool

(76) Inventor: Carl Crisswell, Phoenix, AZ (US)

Correspondence Address: DUNLAP, CODDING & ROGERS P.C., PO BOX 16370, OKLAHOMA CITY, OK, 73113, US

(21) Appl. No.: 11/047,080

(22) Filed: Jan. 31, 2005

(51) Int. Cl. B05C 17/10; A47L 13/08

(52) U.S. Cl. 15/235.6; 15/236.08; 15/236.07; 15/236.05

(57) ABSTRACT

The present invention is a combination squeegee (i.e., a scraper) and hand trowel tool. The tool can be conveniently used to first remove a material from a can, bucket or other material container and then used to spread the material evenly on a surface or substrate. The tool has a blade having a curved edge portion for removing material from cans or buckets and a separate notched edge portion (preferably with indentations or serrations) for evenly spreading the material on a surface. The invention further contemplates a method of using the tool to remove material from a can, bucket or container and applying the material to a surface.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

The present invention generally relates to tools such as scrapers for removing residual material from cans, buckets or similar containers, and also generally relates to trowels for spreading materials on a surface.

The use of scrapers and trowels to remove various materials such as adhesives, grouts, cements, plaster, resin, stucco, paint and the like from cans, buckets or other containers is well known in the prior art. Examples of such scrapping tools are shown for example in U.S. Pat. Nos. 4,355,432; 4,627,128; 4,987,635; and 5,875,515. When using such scrapping tools to apply a material, some material is removed from the container with the tool, then the material is deposited upon the surface to which the material is to be applied such as a surface to be tiled. The user must then put the scrapping tool away and pick up a different tool such as a trowel which is then used to spread the material on the surface. This process of switching from one tool to another then back again can be time consuming and tedious. A tool which functioned to improve the efficiency of this process would be desirable.

### SUMMARY OF THE INVENTION

The present invention is a combination squeegee (i.e., a scraper) and hand trowel tool. The tool can be conveniently used to first remove a material from a can, bucket or other material container and then used to spread the material evenly on a surface or substrate. The tool has a blade having a curved edge portion for efficiently removing residual material from containers such as cans or buckets and a separate notched edge portion (preferably with indentations or serrations) for evenly spreading the material on a surface. The invention further contemplates a method of using the tool to remove material from a can, bucket or container and applying the material to a surface.

### BRIEF DESCRIPTION OF THE DRAWINGS

FIG. 1 is a perspective view of a tool constructed in accordance with the present invention.

FIG. 2 is a cross-sectional view of the tool of FIG. 1 taken along line 2-2.

FIG. 3 is a cross-sectional view of the tool of FIG. 1 taken along line 3-3.

FIG. 4 is a plan view of an alternate embodiment of the invention.

FIG. 5 is a plan view of an alternate embodiment of the invention.

FIG. 6 is a plan view of an alternate embodiment of the invention.

FIG. 7 is a perspective view of an alternate embodiment of the invention.

FIG. 8 is a side cross-sectional view showing the use of the tool of FIG. 1 with a container.

### DETAILED DESCRIPTION OF THE INVENTION

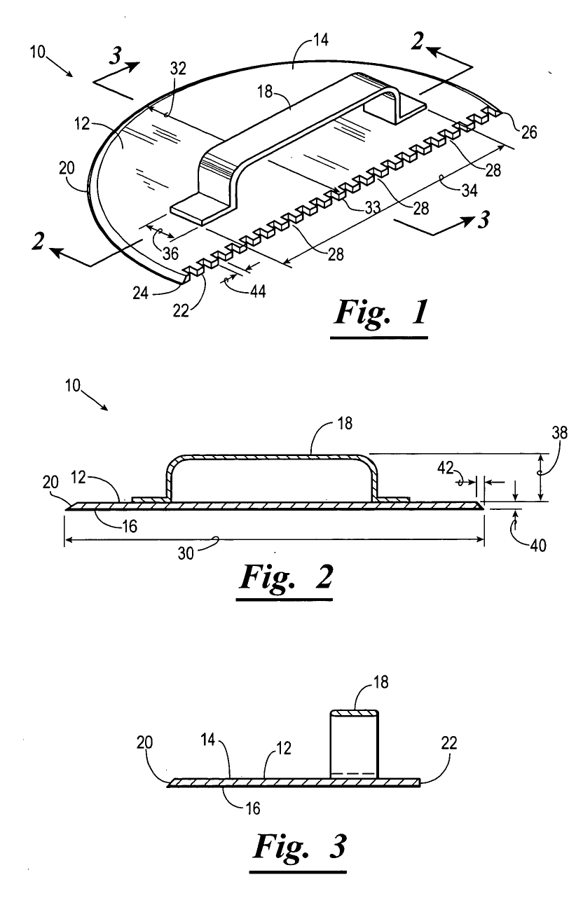

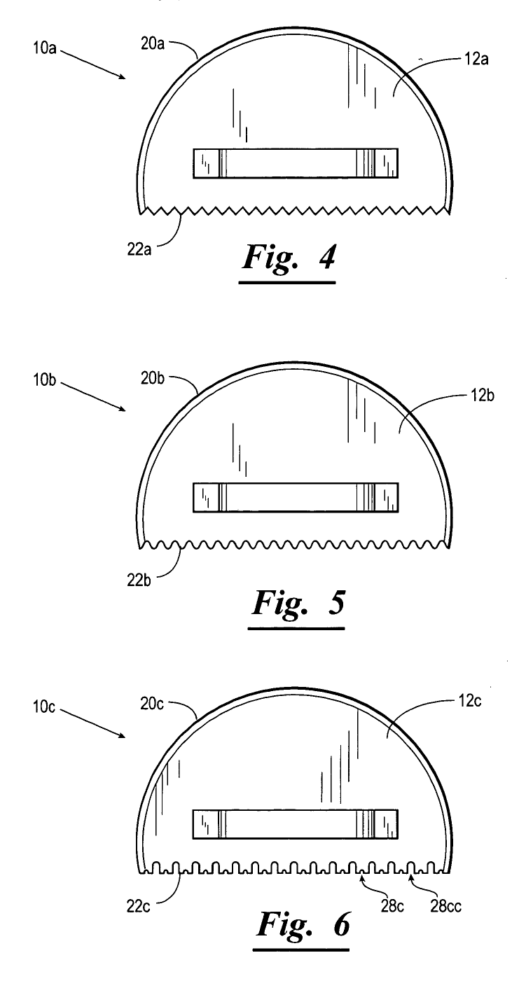

Referring now to the drawings, shown in FIGS. 1-3 is a combination squeegee and hand trowel tool (hereinafter referred to as “tool”) designated by the general reference numeral 10. The tool 10 is provided with a flat blade 12 having an upper surface 14 and a lower surface 16. A handle 18 is releaseably or non-releaseably attached to, and/or extends from the upper surface 14 of the blade 12. The blade 12 in one embodiment has a shape of a half-circle and has a curved edge 20 and notched edge 22. The curved edge 20 extends from a first end 24 of the notched edge 22 to a second end 26 of the notched edge 22. The notched edge 22 includes a plurality of notches 28, only several of which are specifically indicated by the reference numeral 28 in FIG. 1. The notched edge 22 is shown as being crenelate in FIG. 1, but it will be understood by a person of ordinary skill in the art that the notches 28 of the notched edge 22 may have a variety of configurations as explained in more detail below with reference to FIGS. 4-6. The blade 12 has a length 30 (which substantially corresponds to the length of the notched edge 22) and a width 32 which extends perpendicularly from a center point 33 of the notched edge 22 to the curved edge 20. In a preferred version of the invention the length 30 of blade 12 is about 10.25 inches and the width 32 is about 6.75 inches. It will be understood by a person of ordinary skill in the art that the length 30 and width 32 of the blade 12 can vary widely, depending on the diameter of the containers with which the user will use the tool 10.

The length 30 and width 32 of the blade 12 essentially constitute a diameter and a radius, respectively, of an imaginary circle of which the blade 12 constitutes a half circle (the blade 12 may alternatively have a half oval or half elliptical shape, or any other configuration which is appropriate to fit the inner surface of a container). Preferably, the curved edge 30 of the blade 12 has a curvature which conforms to or compliments the curvature of an inner surface of a side wall of a container with which the tool 10 is anticipated to be used. Such containers that contain tile adhesives, grouts, stucco, plasters, or other bonding materials or materials used in construction are well known in the art, thus further discussion herein of the sizes of such containers is not deemed necessary.

As noted above, the tool 10 also includes a handle 18 which has a length 34, a width 36 and a height 38. In a preferred embodiment the length 34 of the handle 18 is about 6.75 inches, the width 36 is about 1 inch and the height 38 is about 1.5 inches. However, it will be understood by a person of ordinary skill in the art that the length 34, width 36 and height 38 of the handle 18 are not to be limited to these particular dimensions. In a preferred embodiment the curved edge 20 of the blade 12 may be beveled to facilitate removal of material from a container. Thus, the curved edge 20 of the blade 12 may have a bevel height 40 of about 0.125 inch and a bevel width 42 of about 0.25 inch. However, as noted above and as understood by a person of ordinary skill in the art, the bevel height 40 and bevel width 42 of the blade 12 are not limited to these dimensions.

As previously noted, the notched edge 22 of the blade 12 is provided with a plurality of notches 28. Each notch 28 has a notch width 44. In a preferred embodiment, the notched edge 22 has a crenelate shape and has a dimension of about 0.25 inch through the notch width 44. However, it should be understood that the notched edge 22 is not to be limited to that particular dimension and that the notch pattern of the blade 12 of the tool 10 of the present invention may vary. For example, shown in FIGS. 4-6 are three other embodiments of a tool of the present invention which have alternate notch patterns. Shown in FIG. 4 is a tool 10a wherein a blade 12a is provided with a notched edge 22a having a serrate or “toothed” pattern. Shown in FIG. 5 is a tool 10b wherein a blade 12b is provided with a notched edge 22b having a crenate or scalloped pattern which is “curved” or “wavy”. Shown in FIG. 6 is a tool 10c wherein a blade 12c is provided with a notched edge 22c having a pattern wherein smaller notches 28c alternate with larger notches 28cc. Other notch patterns will readily be apparent to a person of ordinary skill in the art.

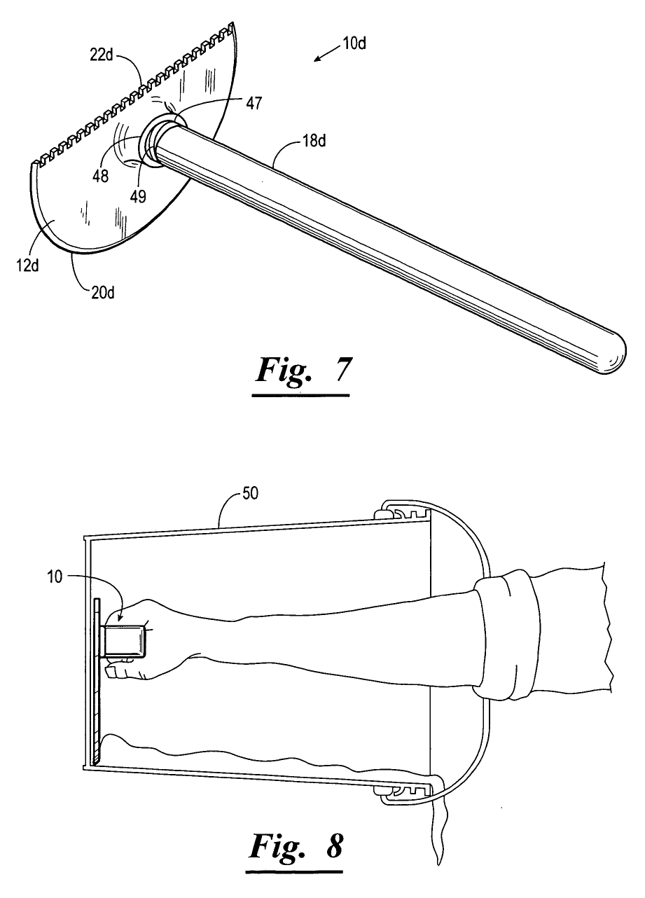

As noted before, the handle 18 of the tool 10 may be releaseably connected, i.e. detachable, from the blade 12. FIG. 7 shows a tool 10d which includes a blade 12d, a handle 18d and a connector assembly 47 for connecting the handle 18d to the blade 12d. The blade 12d is provided with a curved edge 20d and a notched edge 22d. The blade 12d of the tool 10d may be the same as the blade of any other tool described herein. The tool 10d differs from the tools 10-10c described herein in that the handle 18d is detachably connected to the blade 12d.

The connector assembly 47 includes a female connector 48 and a male connector 49. The female connector 48 is formed integrally with the blade 12d so as to extend outwardly therefrom substantially as shown. The male connector 49 is formed on one end of the handle 18d and is adapted to matingly engage the female connector 48 so that the handle 18d can be connected to the blade 12d. Any suitable mechanism can be used as the connector assembly 47. For example, the female connector 48 can include a housing having an opening therein with internally disposed threads and the male connector 49 can be a threaded portion on one end of the handle 18 which can be inserted within the housing for mating engagement with the threads in the housing of the female connector 48 substantially as shown. Thus, the handle 18d can be operably connected or disconnected from the blade 12d via the connector assembly 47.

Any of the tools 10-10d contemplated herein or alternate embodiments of them may be constructed of materials known to be used in the construction of trowels, squeegees, scrapers, or the like, including metals, polymers, plastics (including thermoplastics), rubber, wood, wood products, cardboard, or combinations thereof. The tools 10-10d may be flexible or rigid. In a preferred embodiment the tools described herein such as tools 10-10c are formed as an integral one piece construction molded from a thermoplastic material, although the tool 10d is shown as constructed of separate materials such as a separate blade 12d and a separate handle 18d which are connected together via the connector assembly 47 hereinbefore described.

As to the manner of usage and operation of the tool 10-10d, as shown in FIG. 8, after a cylindrically shaped container 50 has been opened, the tool 10 (or tools 10a-10d, or any other tool described herein) may be inserted therein to effect a removal of a material therefrom. Once the container 50 has been substantially emptied, the curved edge 20-20d of the tool 10-10d, respectively, may be used to remove residual amounts of material from the sidewalls and/or bottom of the container 50 or from beneath an interior rim of the container 50. As such, removal of substantially all material within the container 50 can be effected by utilizing tools 10-10d of the present invention. Furthermore, the tool 10-10d can be utilized to spread or otherwise apply material removed from a container such as container 50 to a surface or substrate in a manner appropriate to the purpose of the material. The container 50 can range in size from 1 to 5 to 10 gallons, for example, but the container can be any size which is typically used in various manners of construction or remodeling as long as the tool 10-10d is sized and configured to removed material from such containers.

It is to be understood that the dimensional relationships of the materials from which the tools 10-10d and the handles 18 and 18d are fabricated, and the components of the tools 10-10d of the invention such as the blades 12-12d or the handles 18 and 18d, can vary, as well as the configuration of the blades 12-12d and the handles 18 and 18d of the tools 10-10d.

Therefore, the foregoing is considered as illustrative only of the tools 10-10d of the present invention. Further, since numerous modifications and changes will readily occur to those skilled in the art, the tools 10-10d and their uses are not limited to the exact construction and operation shown and described, and all suitable modifications and equivalents of the tools 10-10d described herein may be resorted to, and fall within the scope of the present invention.

1. A trowel tool, comprising:
a flat blade having an upper surface, a lower surface, a semicircular edge and a notched edge comprising a plurality of notches, the notched edge having a first end and a second end and the semicircular edge extending from the first end of the notched edge to the second end of the notched edge and wherein the flat blade is absent a straight edge between the semicircular edge and the first end of the notched edge and absent a straight edge between the semicircular edge and the second end of the notched edge and
a handle connected to the flat blade via an upper surface of the flat blade.

2. The trowel tool of claim 1 wherein the plurality of notches in the notched edge comprises a plurality of crenelate notches, serrated notches, crenate notches, scalloped notches, curved notches, or wavy notches, or combinations thereof.

3. The trowel tool of claim 1 wherein the semicircular edge of the flat blade is so dimensioned as to conform to or compliment a curved inner surface of an inner wall of a container.

4. The trowel tool of claim 1 wherein the semicircular edge of the flat blade is beveled.

5. The trowel tool of claim 1 wherein the handle is of unitary construction with the upper surface of the flat blade.

6. The trowel tool of claim 1 wherein the handle is detachably connected to the upper surface of the flat blade.

7. A method of applying a material to a surface, comprising: providing a trowel tool comprising:
a blade having an upper surface, a lower surface, a curved edge and a notched edge, the notched edge having a first end and a second end and the curved edge extending from the first end of the notched edge to the second end of the notched edge, and
a handle connected to the blade via the upper surface of the blade;
disposing the trowel tool within a container containing a material;
removing a quantity of the material from the container via the blade of the trowel tool and disposing the quantity of material onto a surface to which the material is to be applied;
applying the material upon the surface; and
utilizing a portion of the blade of the trowel tool to spread the material on the surface.

8. The method of claim 7 wherein, in the step of providing the trowel tool, the notched edge of the trowel tool comprises a plurality of crenelate notches, serrated notches, crenate notches, scalloped notches, curved notches, or wavy notches, or combinations thereof.

9. The method of claim 7 wherein, in the step of providing the trowel tool, the curved edge of the blade is shaped to conform to or compliment a curved inner surface of an inner wall of the container.

10. The method of claim 7 wherein, in the step of providing the trowel tool, the curved edge of the trowel tool is beveled.

11. The method of claim 7 wherein, in the step of providing the trowel tool, the handle is formed as an integral part of the blade.

12. The method of claim 7 wherein, in the step of providing the trowel tool, the handle is detachably connected to the blade via the upper surface of the blade.

13. The method of claim 7 wherein, in the step of disposing the trowel tool into a container, the container is a can, bucket, or barrel.

14. The method of claim 7 wherein, in the step of disposing the trowel tool into the container, the material in the container is an adhesive, cement, grout, paint, plaster, resin, and/or stucco.

15. The trowel tool of claim 3 wherein the container is a five gallon bucket.
